(19) United States
(12) Patent Application Publication
(10) Pub. No.: US 2015/0236901 A1
(43) Pub. Date: Aug. 20, 2015

(54) CONTROL SYSTEM MANAGEMENT APPARATUS

(71) Applicant: Masaru NAGASHIMA, (US)

(72) Inventor: Masaru Nagashima, Tokyo (JP)

(73) Assignee: Mitsubishi Electric Corporation, Tokyo (JP)

(21) Appl. No.: 14/429,238

(22) PCT Filed: Oct. 4, 2012
(86) PCT No.: PCT/JP2012/075863

§ 371 Date: Mar. 18, 2015

(51) Int. Cl. H04L 12/24

(52) U.S. Cl. CPC H04L 41/082; H04L 41/22

(57) ABSTRACT

A control system management apparatus, includes: a system configuration editor unit including a display unit on which a user designs a network configuration of a control system including networks, at least one relay station, and at least one device to be controlled; an information collection unit collecting, from the relay station, network setting information and routing information; and a network configuration analysis unit analyzing a network configuration of the control system based on the network setting information and the routing information acquired through the information collection unit from a connection station that is any relay station and serves as a starting point, wherein on the basis of the result of the analysis, whether the connection station can communicate with the relay station and the device to be controlled at that point in time is displayed in a network configuration diagram on the display unit.

### FIELD

The present invention relates to a control system management apparatus that collects network setting information and routing information retained by devices in a control system, analyzes the network configuration on the basis of the information, and thereby specifies a device available for communication with the control system management apparatus at the point in time of the analysis and displays the availability of each device for communication.

### BACKGROUND

In recent years, the complexity of network configurations has increased with the increase in the size of control systems. Various communication units with which FA devices connectable to a network are provided, such as programable logic controllers (hereinafter abbreviated as PLCs) and displays (HMIs: human machine interfaces) included in the control system, do not operate correctly unless various parameters dependent on their respective communication modes are set.

Network setting information and routing information are parameters for enabling a control system and each device to operate correctly and are stored in each device as internal data. Thus, a user can verify the parameters of each device one by one. In general, however, users of FA (factory automation) devices are often experts on control systems but not necessarily on networks. It is difficult for a user who is not an expert on networks to figure out the operation of the control system in its entirety from the content of parameters by looking at the parameters of each device.

This situation puts an additional workload on engineers who are not primarily experts on networks and, at the same time, incurs additional cost for constructing a production line due to reasons such as an increase in start time because of setting errors.

Additionally, the range over which devices in a control system can communicate with each other varies with the network setting information and the routing information. Furthermore, devices that a control system management apparatus can communicate with vary depending on which devices in a control system are connected to the control system management apparatus; therefore, the control system management apparatus cannot always access all the devices in the control system.

It is, however, difficult for a user who is not an expert on networks to determine which devices the control system management apparatus can communicate with at that point in time. Some users may wrongly believe that it is possible to communicate with any device on a network as long as it is physically connected via the network. This poses risks of problems, such as inaccessibility of a device and failure of reading from and writing to all the devices collectively in a control system, being caused due to such a misconception by a user about the control system management apparatus.

A conventional control system engineering apparatus includes an online network configuration information collecting unit, which is connected to one of control devices included in a control system and collects network configuration information on a network configuration including networks to which the control devices are connected, and is capable of displaying on a display unit the configurations of the control devices and connection relationships between the control devices and the networks obtained from the online network configuration information.

Additionally, the network configuration information collecting unit is capable of collecting offline connection paths to the control devices in the control system and displaying the offline connection paths such that they are overlaid on online connection paths.

### CITATION LIST

### Patent Literature

Patent Literature 1: Re-publication of PCT International Publication No. 2008/146380

### SUMMARY

### Technical Problem

The control system engineering apparatus in Patent Literature 1 collects, from each PLC, network configuration information, which includes connected network information indicating the networks connected to each PLC and base information indicating the system configuration of the PLCs (the configuration of the units installed on the base), and connection path information, which represents the connection paths to each PLC, in order to create the configurations of the control devices and the connection relationships between the control devices and the networks, i.e., a network configuration diagram. The control system engineering apparatus also creates network information that indicates the configurations of the networks, i.e., the PLCs connected to the networks, from the collected system configuration information.

This invention is problematic in that it takes time to analyze the network configuration because the information is collected from each PLC and the amount of information to be collected is large, i.e., the connected network information, the network configuration information, and the connection path information. There is another problem that every time the number of devices connected to one network increases, the number of queries directed to the devices increases proportionally.

Furthermore, because the conventional control system engineering apparatus displays, as a configuration diagram, the configurations of the devices and the connection relationships between the devices and the networks at that point in time, the configuration diagram indicates merely control devices that are physically connected at that point in time. Another problem with the conventional control system engineering apparatus is that, because the availability of the devices for communication cannot be displayed at that point in time in a configuration diagram a user has already generated, the misconception described above by the user about the control system management apparatus cannot be prevented.

This invention has been achieved in view of the problems described above, and it is an object of the invention to provide a control system management apparatus capable of notifying a user explicitly of devices available for communication and devices unavailable for communication.

### Solution to Problem

In order to solve the above problems and achieve the object, the present invention relates to a control system management apparatus including: a system configuration editor unit including a display unit on which a user designs a network configuration of a control system including a plurality of networks, at least one relay station that relays between the networks, and at least one device to be controlled by the relay station; an information collection unit that collects, from the relay station, network setting information concerning a communication unit mounted on the relay station and routing information concerning the networks connected to the relay station; and a network configuration analysis unit that analyzes a network configuration of the control system on a basis of the network setting information and the routing information acquired through the information collection unit from a connection station that is any relay station and serves as a starting point, wherein on a basis of a result of an analysis performed by the network configuration analysis unit, whether the connection station is able to communicate with the relay station and the device to be controlled at that point in time is displayed in a network configuration diagram on the display unit, the network configuration diagram being designed by using the system configuration editor unit.

### Advantageous Effects of Invention

A control system management apparatus according to the present invention has an advantageous effect in that it is possible to notify a user of devices available for communication and devices unavailable for communication in a control system including a hierarchy of networks. With the advantageous effect described above, the devices available for communication, which vary depending on devices connected to the control system management apparatus, can be presented to the user, and the misconception can be prevented in this manner.

### BRIEF DESCRIPTION OF DRAWINGS

FIG. 1 is a diagram of an exemplary configuration of a control system management apparatus according to an embodiment.

FIG. 2 is a diagram of an exemplary configuration of a control system.

FIG. 3 is a diagram of a network configuration diagram, designed by a user, being displayed on a display unit.

FIG. 4 is a diagram of an example of a network list.

FIG. 5 is a diagram of an example of routing information that has been set.

FIG. 6 is a flowchart illustrating a method of analyzing a network configuration.

FIG. 7 is a diagram of a result of the analysis of the network configuration, being displayed on the display unit.

### DESCRIPTION OF EMBODIMENTS

Exemplary embodiments of a control system management apparatus according to the present invention will be described in detail below with reference to the drawings. The present invention is not limited to the embodiments.

### Embodiment

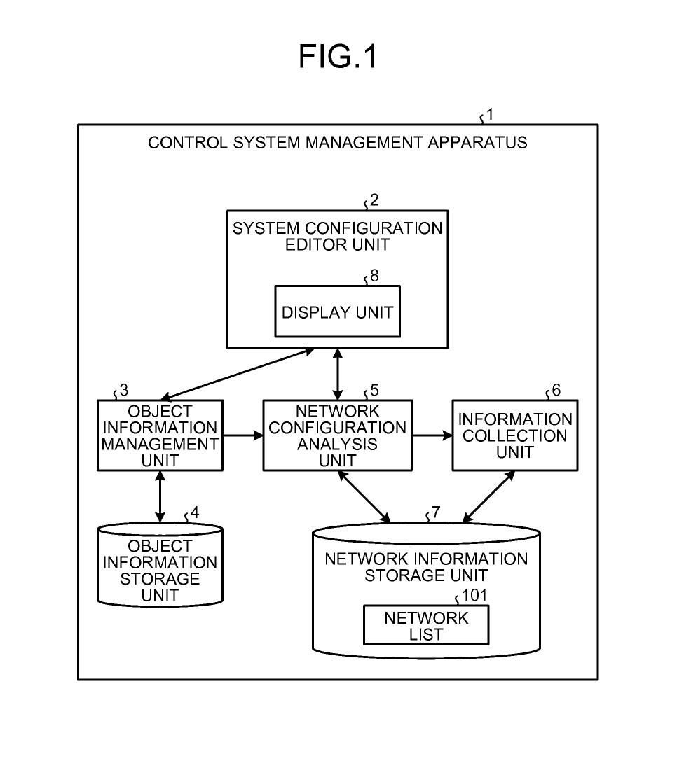

FIG. 1 is a diagram of an exemplary configuration of a control system management apparatus 1 according to an embodiment of the present invention.

With reference to FIG. 1, the control system management apparatus 1 includes a system configuration editor unit 2, an object information management unit 3, an object information storage unit 4, a network configuration analysis unit 5, an information collection unit 6, and a network information storage unit 7.

The system configuration editor unit 2 is a graphical user interface unit capable of generating on a desktop a visual layout diagram of a control system and defining a network configuration of the control system. Devices as described above refer to constituent elements of the control system, such as programmable logic controllers (PLCs), displays, numerical control devices (NCs), and field devices (e.g., sensors, valves, motors, servo amplifiers, inverters, and robots).

The system configuration editor unit 2 includes a display unit 8, which displays various types of information for a user, and an input unit, which receives instructions input by the user.

Information generated by the user concerning the network configuration of the control system is stored by the object information management unit 3 in the object information storage unit 4. The object information management unit 3 updates the object information storage unit 4 in synchronization with the operation in the system configuration editor unit 2 to place, move, or delete an object (a device, a unit, and a network) in a network configuration diagram. Thus, the object information storage unit 4 is kept consistent with objects placed in the system configuration editor unit 2.

The network configuration analysis unit 5 analyzes the network configuration on the basis of network setting information and routing information collected by the information collection unit 6 from the devices of the control system. Various pieces of information collected by the information collection unit 6 are stored temporarily in the network information storage unit 7.

Upon receipt of an instruction from the system configuration editor unit 2 to analyze the network configuration, the network configuration analysis unit 5, while referring to the content of the network information storage unit 7, instructs the information collection unit 6 what information to acquire from which device in the control system. The information collection unit 6 stores in the network information storage unit 7 information acquired from the device. The network configuration analysis unit 5 reports the result of the analysis of the network configuration to the system configuration editor unit 2.

The system configuration editor unit 2 highlights on the network configuration diagram a relevant device corresponding to a device that is available for communication, on the basis of the result of the analysis of the network configuration received from the network configuration analysis unit 5.

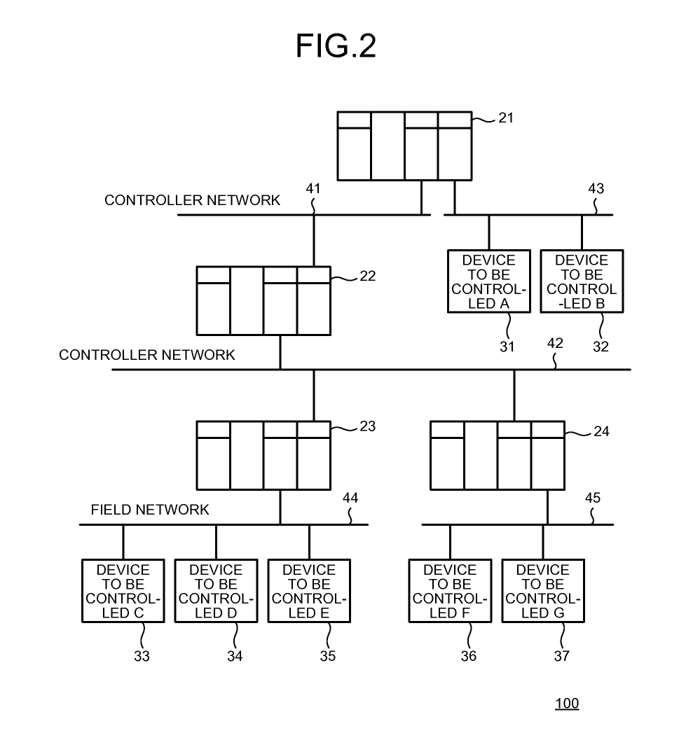

FIG. 2 is a diagram of an exemplary configuration of a control system 100. In the following explanation, a device directly connected to the control system management apparatus 1 is referred to as a connection station, a device that manages each network as a master station, and a device connected to a plurality of networks as a relay station. A relay station refers to a device that is connected to a plurality of networks and is capable of relaying communication data from one network to another network. In the control system 100, PLCs and displays correspond to relay stations.

In the exemplary configuration illustrated in FIG. 2, the control system 100 includes four PLCs 21 to 24 and seven devices to be controlled 31 to 37. These devices are connected via two controller networks 41 and 42 and three field networks 43 to 45. The PLCs 21 to 24, which can relay between more than one network, are relay stations.

In the description of the present embodiment, the controller networks 41 and 42 and the field networks 43 to 45 are also referred to generically as a network.

The controller networks 41 and 42 and the field networks 43 to 45 according to the present embodiment are characterized by master stations collecting information on all the slave stations and collectively managing the information when the networks are initialized. These networks are each initialized when all the devices connected to its corresponding network is turned ON. The networks are also each initialized when any device that is connected to its corresponding network and is not the master station fails, when the power to such a device is turned OFF, or when the power to such a device is turned ON again. A slave station refers to a device that is connected to any of the networks and is not the master station.

The controller networks 41 and 42 and the field networks 43 to 45 according to the present embodiment are also characterized by the provision of station numbers indicating the master station and the ability to collect information from the master station by specifying a network number, which is an identification number of a network, and a station number indicating the master station.

A specific example of the controller networks 41 and 42 according to the invention is a CC-Link IE control network. A specific example of the field networks 43 to 45 is a CC-Link IE field network.

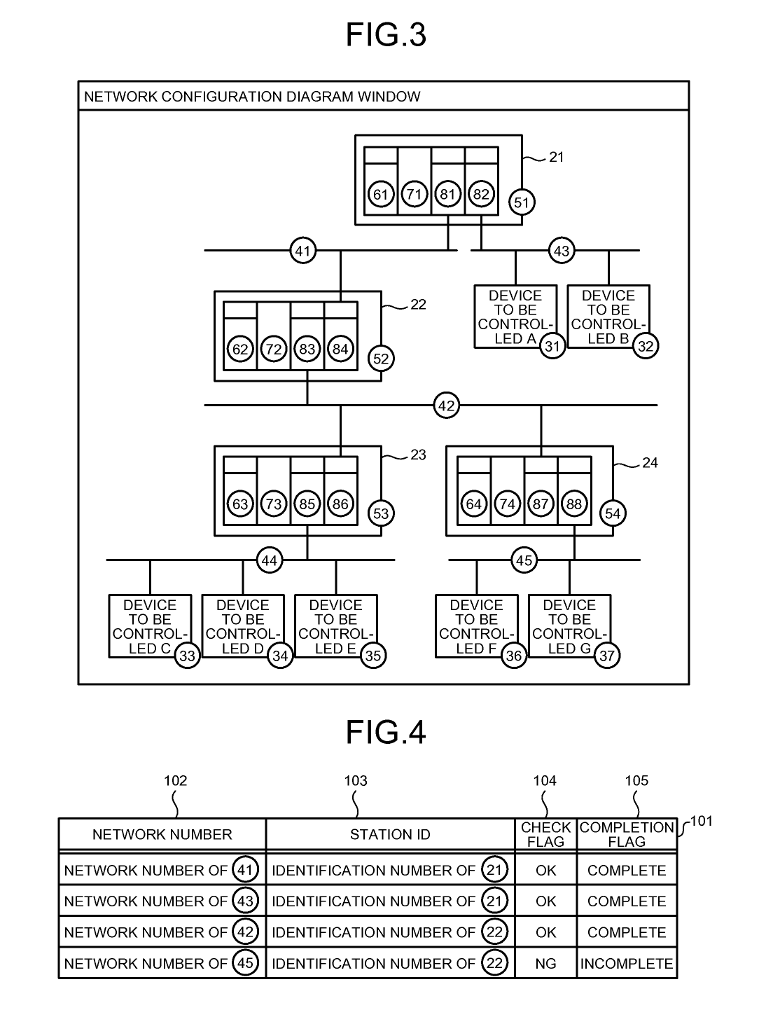

FIG. 3 is a diagram of a network configuration diagram, concerning the configuration of the control system 100 illustrated in FIG. 2, being displayed on the display unit 8, where the network configuration diagram has been designed by the user by using the system configuration editor unit 2 of the control system management apparatus 1. In the example illustrated in FIG. 3, the four PLCs 21 to 24 and the seven devices to be controlled 31 to 37 are placed.

The PLCs 21 to 24 are each configured by mounting various units on a base unit.

Specifically, the PLC 21 is such that a power unit 61, a CPU unit 71, a controller network communication unit 81, and a field network communication unit 82 are mounted on a base unit 51.

The PLCs 22 to 24 are configured in a similar manner with various units combined.

The PLC 22 is such that a power unit 62, a CPU unit 72, and controller network communication units 83 and 84 are mounted on a base unit 52.

The PLC 23 is such that a power unit 63, a CPU unit 73, a field network communication unit 85, and a controller network communication unit 86 are mounted on a base unit 53.

The PLC 24 is such that a power unit 64, a CPU unit 74, a controller network communication unit 87, and a field network communication unit 88 are mounted on a base unit 54.

The power units 61 to 64 supply power to the CPU units 71 to 74 and the communication units 81 to 88 mounted on the respective base units 51 to 54 on which the power units 61 to 64 are respectively mounted.

The CPU units 71 to 74 each store programs for controlling the various units and parameter information for the various units mounted on the identical PLC, define conditions for the various units on the identical PLC in accordance with the stored parameter information, and control the various units by executing the stored programs.

The communication units 81 to 88 are units for each connecting to a relevant network and communicating with other devices.

The controller network communication units 81, 83, 84, 86, and 87 are connected via the controller networks 41 and 42; therefore, the PLCs 21 to 24 share their respective control information with each other.

The field network communication units 82, 85 and 88 are connected via the field networks to the devices to be controlled 31 to 37 to allow the PLCs to control the devices to be controlled 31 to 37. Specifically, the field network communication unit 82 is connected to a device to be controlled A31 and a device to be controlled B32 via the field network 43. The field network communication unit 85 is connected to a device to be controlled C33, a device to be controlled D34, and a device to be controlled E35 via the field network 44. The field network communication unit 88 is connected to a device to be controlled F36 and a device to be controlled G37 via the field network 45.

In the present embodiment, to identify objects (devices, units, and networks) placed on a network configuration diagram, an object ID, which is an identification number unique within the control system 100, is assigned to each object. In FIG. 3, the values in the circles indicate object IDs.

FIG. 4 shows a network list 101 stored in the network information storage unit 7.

The network list 101 includes a network number 102, a station ID 103, a check flag 104, and a completion flag 105.

The network number 102 represents an identification number uniquely assigned to each network of the control system 100.

The station ID 103 indicates an identification number for a connection station or a relay station set in the routing information. The station ID 103 represents an identification number uniquely assigned to each device in a network configuration diagram described by using the system configuration editor unit 2.

The check flag 104 indicates a flag for judging whether or not the network configuration analysis unit 5 analyzes a network configuration. If the check flag 104 shows “OK”, it indicates that a network configuration is a target for the analysis. If the check flag 104 shows “NG”, it indicates that a network configuration is not a target for the analysis, which clarifies a network number with the routing information including an error.

The completion flag 105 indicates that the analysis of the network configuration is completed.

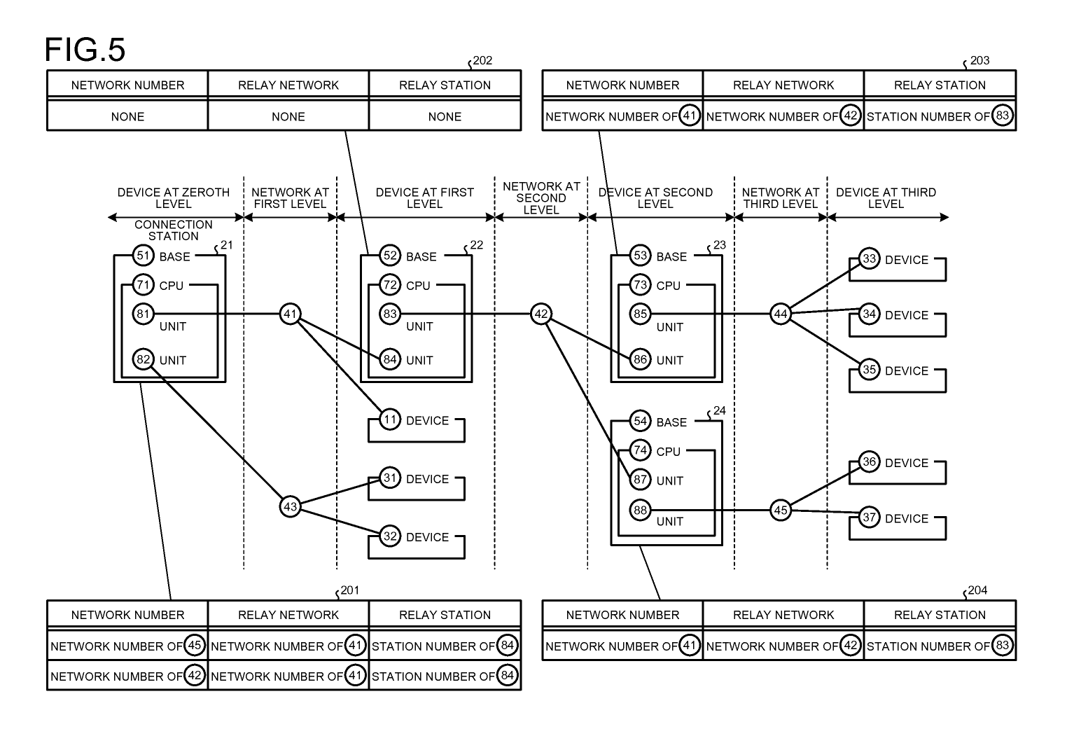

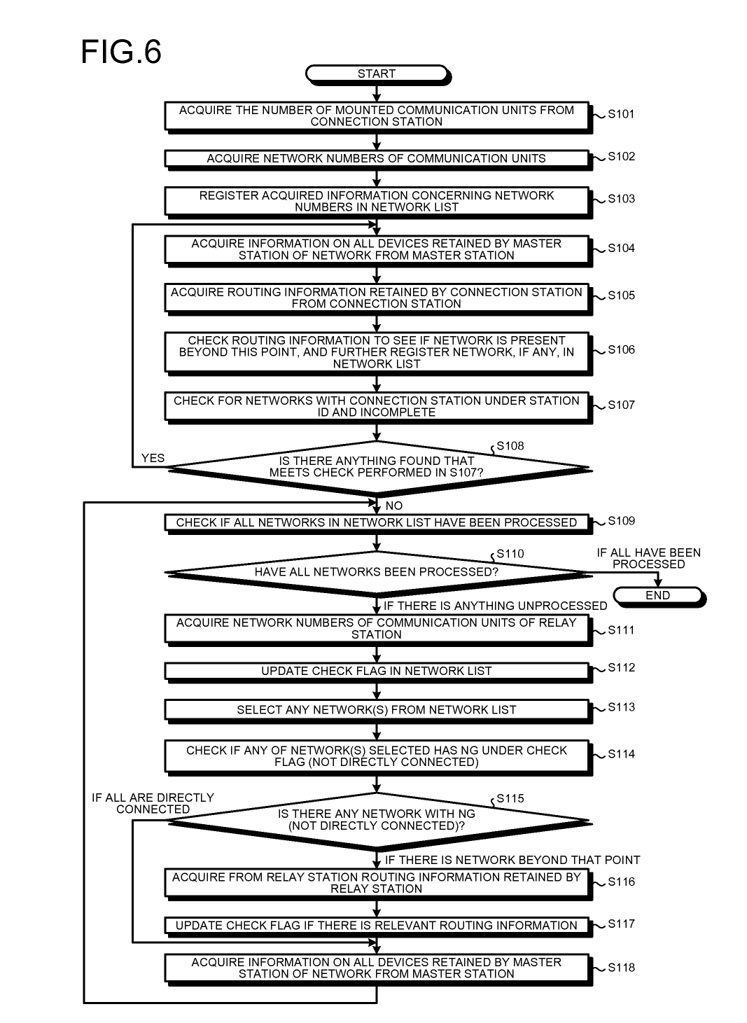

A method of analyzing the network configuration using the control system management apparatus 1 according to the present embodiment will be described below with reference to FIGS. 5 and 6. Here, a case where the control system management apparatus 1 is connected to the PLC 21 is taken as an example. In this case, the PLC 21 is the connection station.

FIG. 5 is a diagram of an example of routing information set for the PLCs 21 to 24 illustrated in FIG. 3.

It is assumed that the control system 100 is designed to enable the PLC 21 to communicate with the controller networks 41 and 42 and the field networks 43 and 45. It is, however, also assumed that, due to a setting error in the routing information, the PLC 21 cannot communicate with the field network 45.

Specifically, routing information 201 for the PLC 21 is set correctly so that the PLC 21 can communicate with the controller network 42 and the field network 45. Note that the PLC 21 can communicate with the controller network 41 and the field network 43, which are directly connected to the PLC 21, without the routing information.

It is also assumed that routing information 202 is not set for the PLC 22. For the PLC 21 to be able to communicate with the field network 45, the network number for the field network 45 should be set under the network number, the network number for the controller network 42 should be set under the relay network, and the station number for the controller network communication unit 87 should be set under the relay station with the routing information.

Routing information 203 for the PLC 23 is correctly set so that the PLC 23 can communicate with the controller network 41 and the field network 44.

Routing information 204 for the PLC 24 is correctly set so that the PLC 24 can communicate with the controller network 41 and the field network 45.

The control system management apparatus 1 is connected to any device in the control system 100 and determines whether it is possible to communicate with all the other devices through the connected device (the connection station) serving as a starting point. Any device in the control system 100 can be the starting point and can be specified as the starting point by a user at the discretion of the user by using the system configuration editor unit 2.

FIG. 6 is a flowchart illustrating a method of analyzing a network configuration.

Upon receipt of an instruction from the system configuration editor unit 2 to analyze the network configuration, the network configuration analysis unit 5 starts analyzing the network configuration, with the connection station to which the control system apparatus 1 is connected at this point in time, which is the PLC 21, serving as the starting point.

The network configuration analysis unit 5 acquires through the information collection unit 6 the network setting information on the connection station, which is the PLC 21. Specifically, the network configuration analysis unit 5 acquires the number of communication units mounted on the connection station, which is the PLC 21 (step S101). In the example illustrated in FIG. 5, because the PLC 21 includes two communication units mounted thereon, i.e., the controller network communication unit 81 and the field network communication unit 82, the network configuration analysis unit 5 can acquire two as the number of mounted communication units.

Then, the network configuration analysis unit 5 acquires the network numbers set for the communication units (step S102). Note that the network setting information may include the network numbers (identification numbers) set for the communication units, i.e., the network numbers (identification numbers) of the networks connected to the communication units. In the example illustrated in FIG. 5, the network number of the controller network 41 is acquired for the controller network communication unit 81, and the network number of the field network 43 is acquired for the field network communication unit 82.

The network configuration analysis unit 5 registers in the network list 101 the identification number of the connection station and the network numbers of the controller network 41 and the field network 43 acquired in step S102 (step S103). At this point in time, the station ID 103 is set to the identification number of the connection station, the check flag 104 is set to “OK”, and the completion flag 105 is set to “incomplete.”

The network configuration analysis unit 5 then acquires information on all the devices retained by the master stations of the networks to which the network numbers acquired in step S103 are allotted (step S104). At this point in time, the network configuration analysis unit 5 sets the completion flag 105 to “complete” where applicable.

The network configuration analysis unit 5 also acquires from the connection station the routing information retained by the connection station (step S105). The network configuration analysis unit 5 checks the routing information to see if a network is present beyond this point (step S106). In the example illustrated in FIG. 5, it is determined from the routing information 201 that the controller network 42 and the field network 45 are present in the case of the connection station, which is the PLC 21.

The network configuration analysis unit 5 further registers in the network list 101 the network number that has been found. At this point in time, the station ID is set to a station ID that is assigned to the device on which the communication unit set in the routing information as a relay station is mounted. In the example illustrated in FIG. 5, the station ID for the PLC 22, the network number of the controller network 42, and the network number of the field network 45 are registered. At this point in time, the station ID 103 is set to the identification number of the connection station, the check flag 104 is set to “OK”, and the completion flag 105 is set to “incomplete”.

In the example illustrated in FIG. 5, although the network number 44 is physically present, it is not registered because it is not set in the routing information 201.

The network configuration analysis unit 5 checks the network numbers registered in the network list 101 to see if there is a network number with which the station ID is set to the station number of the connection station and the completion flag is set to “incomplete” (step S107).

If there is anything found that meets the check performed in step S107 ([Yes] in step S108), the flowchart returns to step S104 to perform the processes in steps S104 to S107. In this manner, the process for all the networks directly connected to the connection station is completed.

If there is nothing found that meets the check performed in step S107 ([No] in step S108), the flowchart proceeds to the next process (in step S109).

In the example illustrated in FIG. 5, because the field network 43 is another network that is connected to the connection station, the processes in steps S104 to S107 are performed for this network. When the processes have been performed, the completion flag 105 is set to “complete”.

In the case of [No] in step S108, the network configuration analysis unit 5 checks if all the network numbers registered in the network list 101 have been processed (step S109). If all the network numbers have been processed ([if all have been processed] in step S110), the network configuration analysis is completed.

If there is any network number that has not been processed ([if there is anything unprocessed] in step S110), the network configuration analysis is continued to proceed to step S111.

The network configuration analysis unit 5 first acquires the network setting information from a relay station through the information collection unit 6 and acquires network numbers set for communication units mounted on the relay station (step S111).

The network configuration analysis unit 5 checks the network list 101 to see if the target relay station in step S111 matches any of the stations in the list, and sets the check flag 104 to “OK” for the network number of the matching station if the network number has been acquired in step S111 and sets the check flag 104 to “NG” for the network number of the matching station if the network number has not been acquired in step S111 (step S112).

The network configuration analysis unit 5 selects any network(s) from among the networks allotted to the network numbers acquired in step S111 (step S113), and perform the processes in steps S114 to S118 below.

The network configuration analysis unit 5 checks the network list 101 to see if the check flag of any of the network number(s) acquired in step S113 is set to “NG” (step S114). A network with the check flag showing “NG” at this point in time indicates that this network is not directly connected to the target relay station in step S111 but is located beyond the target relay station.

If there is no check flag set to “NG” ([if all are directly connected] in step S115), it indicates that there is no network beyond that point, and the flowchart proceeds to step S118.

If there is a check flag set to “NG” ([if there is a network beyond that point] in step S115), the network configuration analysis unit 5 collects the routing information on the relay station through the information collection unit 6 (step S116).

The network configuration analysis unit 5 checks the routing information collected in step S116 to verify that a network is present beyond that point, and sets again the check flag 104 to “OK” for a network number that is for the network and for which the completion flag 105 shows “incomplete” in the network list 101 (step S117).

The network configuration analysis unit 5 acquires through the information collection unit 6 information on all the devices retained by the master stations of the networks to which the network numbers acquired in step S111 are allotted (step S118). At this point in time, the network configuration analysis unit 5 sets the completion flag 105 to “complete” where applicable.

Specific operations performed on a relay station will now be described using the example illustrated in FIG. 5.

The relay station (PLC) 22 that is connected to the controller network 42 is looked at first. The network configuration analysis unit 5 acquires through the information collection unit 6 the network setting information on the relay station 22 and acquires the network numbers set for the controller network communication units 83 and 84 mounted on the relay station 22 (step S111).

The check flag 104 corresponding to the network number in which the station ID 103 is set to the relay station 22 and the completion flag 105 is set to “incomplete” is updated in accordance with the network numbers acquired in step S111 (step S112). In other words, the check flag for the controller network 42 is set to “OK” and the check flag for the field network 45 is set to “NG.” The network configuration analysis unit 5 selects any networks from among the networks to which the network numbers acquired in step S111 are allotted (step S113) and checks the network list 101 to see if the check flag shows “NG” for the network numbers acquired in step S113 (step S114).

Because the check flag for the field network 45 is “NG” ([if there is a network beyond that point] in step S115), the network configuration analysis unit 5 then collects through the information collection unit 6 the routing information on the relay station (step S116). In the example illustrated in FIG. 5; however, because the routing information on the relay station 22 is not set, the check flag remains “NG” and the completion flag remains “incomplete” (step S117). In other words, this indicates that there is a setting error, which constitutes inconsistency, for the field network 45.

The network configuration analysis unit 5 acquires through the information collection unit 6 information on all the devices retained by the master station of the controller network 42 (step S118). The network configuration analysis unit 5 then sets the completion flag 105 to “complete” where applicable.

As described above, the analysis of the network configuration discovers that the control system management apparatus 1 is able to communicate with the devices connected to the controller network 41, the controller network 42, and the field network 43. Additionally, the network list 101 with the completion flag 105 still showing “incomplete” indicates that there is a setting error for the field network 45.

The fact that the field network 44 is not registered in the network list 101 indicates that no path is intentionally set from the control system management apparatus 1 to the devices to be controlled 33 to 35, which are connected only to the field network 44.

The network configuration analysis unit 5 notifies the system configuration editor unit 2 of the network numbers with the completion flag 105 set to “OK” in the network list 101 as the result of the analysis of the network configuration.

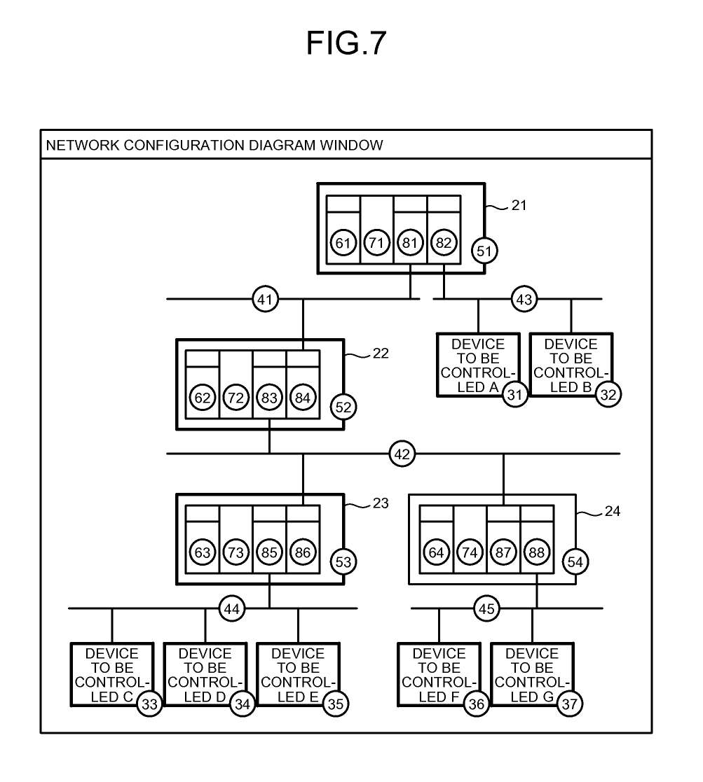

On the basis of the network numbers, the system configuration editor unit 2 determines, through the object information management unit 3, the devices connected to the networks of the network numbers. On the basis of the result thereof, the system configuration editor unit 2 highlights in the display unit 8 the relevant devices on a network configuration window 6, as illustrated in FIG. 7.

In general, depending on the settings of the setting information and the routing information, all devices (including a control system management apparatus) in a control system cannot always communicate with each other within the control system even though the devices are physically connected via networks. Although a user can verify the network setting information and the routing information set for each device one by one, it is difficult for the user to figure out the operation of the control system in its entirety just by looking at the setting information. Hence, when the user of the control system management apparatus connects to a device within the control system, it is difficult to determine which devices are available at that point in time for communication, and the misconception that it is possible to communicate with a device that is physically connected via a network has caused problems, such as inaccessibility of a device or failure of reading from and writing to all the devices collectively in the control system.

In contrast, the control system management apparatus according to the present embodiment analyzes the network configuration on the basis of the network setting information and the routing information retained by the devices in a control system, and is thus capable of specifying devices that are available for communication with the control system management apparatus at that point in time and notifying the user explicitly of the devices available for communication and devices unavailable for communication. Additionally, the control system management apparatus according to the present embodiment limits the target devices from which the network setting information is collected to a device directly connected to the control system management apparatus, to a device that manages each network, and to a device connected to a plurality of networks and is thus capable of analyzing the network configuration in a reduced period of time.

The control system management apparatus according to the present embodiment uses the routing information set in the devices in order to reduce the number of times information is collected from the devices. The original purpose of the routing information is for deciding to which network a relay station relays a received communication frame. In the embodiment described above, the target devices from which the routing information is collected are limited to a connection station and a relay station.

In other words, with the present embodiment, it is possible to notify a user of devices available for communication and device unavailable for communication in a control system including a hierarchy of networks. With this capability, the user is presented with devices available for communication, which vary depending on devices connected to the control system management apparatus, and in this manner, the misconception of the user can be prevented.

Furthermore, the period of time during which the network configuration is analyzed can be reduced by taking advantage of the characteristics of the controller network and the field network and by limiting devices from which information is acquired. With this approach, it is possible to prevent the imposition of additional stress on the user in terms of the operation and performance of the control system management apparatus. Additionally, the capability of finding inconsistency in the routing information during the analysis of the network configuration is provided. With this capability, the location of a setting error can be indicated for the user, which reduces the burdensome work of searching for where to correct a setting and thereby reduces the period of time to start a network and facilitates starting the network.

Furthermore, the present invention of the application is not limited to the above embodiments and can be variously modified at the execution stage without departing from the scope thereof. Moreover, the above-described embodiments include inventions in various stages and various inventions can be extracted by appropriately combining a plurality of disclosed components. For example, even if some components are omitted from all the components illustrated in the above embodiments, the configuration in which some components are omitted can be extracted as an invention as long as the problems described in the section of Technical Problem can be solved and the effects described in the section of Advantageous Effects of Invention can be obtained. Furthermore, the components in the different embodiments may be appropriately combined.

### INDUSTRIAL APPLICABILITY

As described above, the control system management apparatus according to the present invention is useful as a control system management apparatus applicable to a control system including FA devices connectable to a network, such as a programmable logic controller (PLC) and a display (HMI), and is particularly suitable for a control system engineering apparatus.

### REFERENCE SIGNS LIST

1 control system management apparatus, 2 system configuration editor unit, 3 object information management unit, 4 object information storage unit, 5 network configuration analysis unit, 6 information collection unit, 7 network information storage unit, 8 display unit, 21 to 24 PLC, 31 to 37 device to be controlled, 41 and 42 controller network, 43 to 45 field network, 51 to 54 base unit, 61 to 64 power unit, 71 to 74 CPU unit, 81 controller network communication unit, 82 field network communication unit, 83 and 84 controller network communication unit, 85 field network communication unit, 86 to 87 controller network communication unit, 88 field network communication unit, 100 control system, 101 network list, 102 network number, 103 station ID, 104 check flag, 105 completion flag, 201 to 204 routing information.

1. A control system management apparatus, comprising:
a system configuration editor unit including a display unit on which a user designs a network configuration of a control system including a plurality of networks, at least one relay station that relays between the networks, and at least one device to be controlled by the relay station;
an information collection unit that collects, from the relay station, network setting information concerning a communication unit mounted on the relay station and routing information concerning the networks connected to the relay station; and
a network configuration analysis unit that analyzes a network configuration of the control system on a basis of the network setting information and the routing information acquired through the information collection unit from a connection station that is any relay station and serves as a starting point, wherein
on a basis of a result of an analysis performed by the network configuration analysis unit, whether the connection station is able to communicate with the relay station and the device to be controlled is displayed in a network configuration diagram on the display unit, the network configuration diagram being designed by using the system configuration editor unit.

2. The control system management apparatus according to claim 1, wherein the network configuration analysis unit analyzes a network configuration of the control system also on a basis of the network setting information and the routing information from the relay station that is not the connection station.

3. The control system management apparatus according to claim 1, wherein the network setting information includes identification numbers of the networks connected to the communication unit.

4. The control system management apparatus according to claim 1, wherein the routing information includes identification numbers of the networks and an identification number of the relay station.
